(19) United States
(12) Patent Application Publication
(10) Pub. No.: US 2015/0046365 A1
(43) Pub. Date: Feb. 12, 2015

(54) UNIVERSAL ADDRESS SERVICE

(71) Applicant: eBay Inc., San Jose, CA (US)

(72) Inventor: Kamal Zamer, Austin, TX (US)

(73) Assignee: eBay Inc., San Jose, CA (US)

(21) Appl. No.: 13/962,421

(22) Filed: Aug. 8, 2013

(51) Int. Cl. G06Q 10/08

(52) U.S. Cl. CPC G06Q 10/0838
USPC 705/341

(57) ABSTRACT

A system and method for universal address service are described. Shipping delivery data related to a user is accessed. The shipping delivery data comprises a history of shipping delivery addresses with corresponding shipping delivery dates. A predicted shipping delivery address for the user is determined based on an estimated delivery date of an order from the user and the shipping delivery data related to the user. The order is generated with the predicted shipping delivery address.

### TECHNICAL FIELD

This application relates generally to the field of computer technology and, in a specific example embodiment, to a method and system for universal shipping address service.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

The buyer typically specifies the destination address where the buyer would like the item to be shipped. The destination address may be, for example, a residence address or a business address of the buyer. However, the buyer may be required to be physically present at the destination address for items requiring a signature confirmation. When the buyer misses the delivery, the buyer typically would have to pick up the item at a predetermined location, which causes frustration and wasted time.

### BRIEF DESCRIPTION OF THE DRAWINGS

The present disclosure is illustrated by way of example, and not by way of limitation, in the figures of the accompanying drawings in which:

FIG. 1 is a network diagram depicting a network system, according to one embodiment, having a client-server architecture configured for exchanging data over a network.

FIG. 2 shows a block diagram illustrating one example embodiment of a marketplace application.

FIG. 3 shows a block diagram illustrating one example embodiment of a universal address service application.

FIG. 4A shows a ladder diagram illustrating one example embodiment of an operation of a universal address service application.

FIG. 4B shows a ladder diagram illustrating another example embodiment of an operation of a universal address service application.

FIG. 5A shows a flow diagram illustrating one example embodiment of a method for a universal address service.

FIG. 5B shows a flow diagram illustrating another example embodiment of a method for a universal address service.

FIG. 6 shows a diagrammatic representation of machine in the example form of a computer system within which a set of instructions may be executed to cause the machine to perform any one or more of the methodologies discussed herein.

### DETAILED DESCRIPTION

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for universal address service are described. Shipping delivery data related to a user is accessed. The shipping delivery data comprises, for example, a history of shipping delivery addresses with corresponding shipping delivery dates for the user. An estimated delivery date is determined for an order placed by the user. A predicted shipping delivery address for the user is determined based on the estimated delivery date of the order and the shipping delivery data related to the user. The order is generated with the predicted shipping delivery address.

### System Architecture

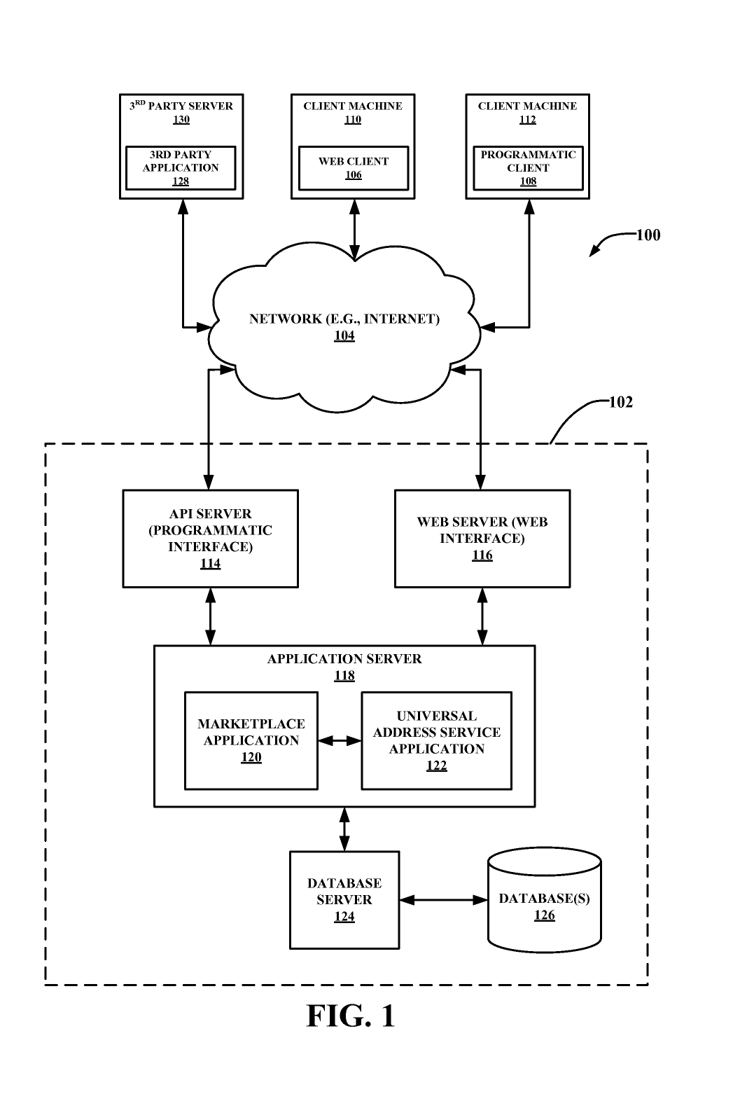

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as peer-to-peer or distributed network environments.

A data exchange platform, in an example form of a marketplace application 120 and a universal address service application 122, may provide server-side functionality, via a network 104 (e.g., the Internet) to one or more clients. The one or more clients may include users that utilize the network system 100 and, more specifically, the marketplace application 120 and the universal address service application 122, to exchange data over the network 104. These transactions may include transmitting, receiving (communicating), and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, with each in communication with the networked system 102 and optionally each other. The buyers and sellers may be any one of individuals, merchants, or service providers.

Turning specifically to the marketplace application 120 and the universal address service application 122, an application program interface (API) server 114 and a web server 116 are coupled to, and provide programmatic and web interfaces respectively to, one or more application servers 118. The application server 118 hosts one or more marketplace applications 120 and one or more universal address service applications 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the universal address service application 122 includes a system and a method for generating a suggested shipping delivery address for a buyer of the marketplace application 120 prior to finalizing an order. The suggested shipping delivery address may be based on a history of shipping delivery addresses and corresponding delivery dates of the buyer. In another embodiment, the universal address service application 122 includes a system and a method for generating a request to a shipping carrier associated with the order to hold or redirect delivery of an item that has already been shipped.

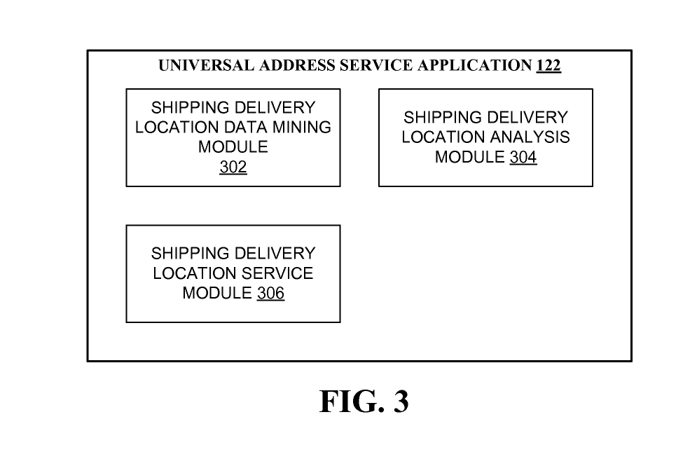

For example, the universal address service application 122 determines whether the buyer is out of town or otherwise unavailable to receive the shipment at the estimated time of delivery. The determination may be based on access to the historical shipping delivery address of the buyer and corresponding delivery dates, communications (e.g., emails, social network posting) to or from the buyer, location of the buyer (e.g. using GPS data of the mobile device of the buyer). Based on that determination, the universal address service application 122 generates a request to a corresponding shipping service provider to hold, redeliver, or redirect to an alternative shipping delivery address for an order that has already been fulfilled. The universal address service application 122 is described in more detail below with respect to FIG. 3.

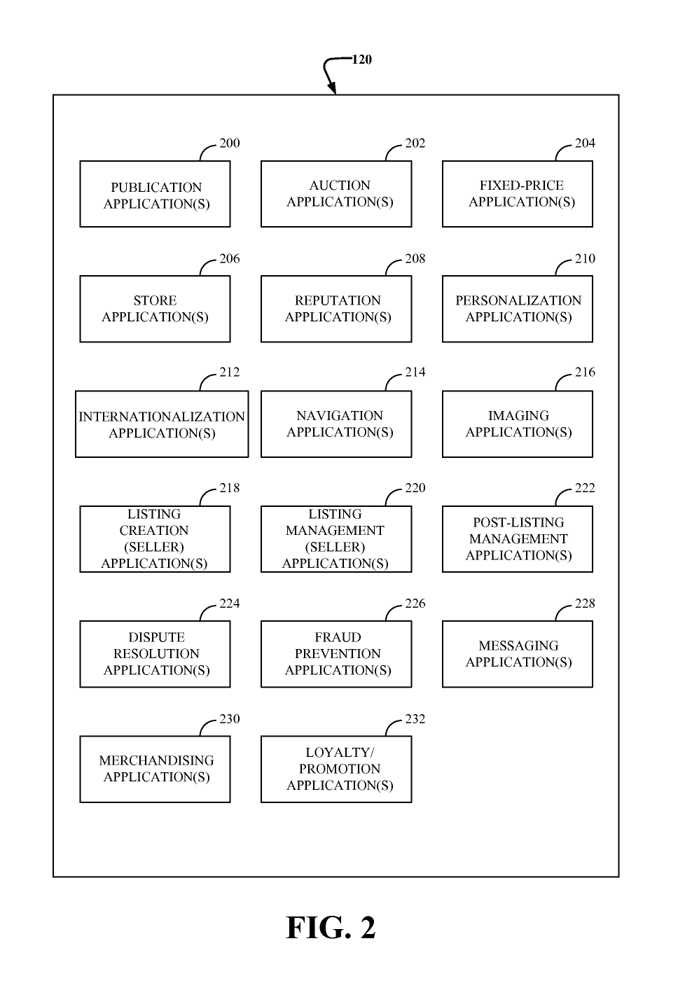

FIG. 2 shows a block diagram illustrating one example embodiment of the marketplace application 120. The marketplace application 120 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the universal address service application 122. The universal address service application 122 may include a shipping delivery location data mining module 302, a shipping delivery location analysis module 304, and a shipping delivery location service module 306.

In one embodiment, the shipping delivery location data mining module 302 accesses shipping delivery data related to a user of the marketplace application 120. The shipping delivery data may include, for example, a history of shipping delivery addresses with corresponding shipping delivery dates of the user, social network data related to the user (related to the marketplace application 120 and to a third party social network application outside the marketplace application 120), geographic location data (e.g., GPS location data) of a mobile device of the user, and communication data (e.g., emails, text, messages) to or from the user.

The history of shipping delivery addresses may be stored in a table or database that includes past shipping delivery addresses, corresponding shipping dates and delivery dates, item(s) shipped, and whether the item was successfully received, or held for pick up at a shipping facility because a signature was required. As such, a trend or a pattern may be determined from the history of shipping delivery addresses to predict whether a user of the marketplace application 120 prefers to have a purchased item delivered to a particular shipping delivery address during a certain period of time. For example, a buyer may prefer to have his items delivered to his summer residence in July and August, winter residence in December and January, and his primary residence for the remainder of the year.

In another embodiment, the delivery address may be determined based on the type of product being ordered. For example, the history of shipping delivery addresses may show that toiletry items are typically delivered at a home address of the buyer while office supplies are delivered at the work address of the buyer.

The social network data may include parsed social network data for communication related to, for example, a travel plan or itinerary of the user. For example, the user may be posting a status update such as “looking forward to Kona at the end of August.” The social network data may be parsed for information indicative of the user's present or future geographic location, such as whether the buyer in the marketplace application 120 is or will be out of town and for how long. For example, the user may use another social network service to “check-in” at a hotel or restaurant. The distance between the hotel or restaurant checked-in and the typical shipping delivery address of the user is computed to determine whether the distance exceeds a threshold distance (e.g., more than 100 miles away from home). If the location of the user exceeds the threshold distance, the user may be deemed to be out of town. It is noted that the publication of these types of items information may be user-controlled for added privacy. For example, the user may first consent to the monitoring of the user's social feed to determine whether they are out of town.

The geographic location data may include GPS data from a mobile device of the user of the marketplace application 120. For example, the shipping delivery location data mining module 302 parses the geographic location data of the mobile device of the user to determine whether a threshold distance between a location of the mobile device and the default shipping delivery location exceeds a threshold distance (e.g., more than 50 miles) for a number of days (e.g., for more than two days). For example, the GPS data of the mobile device of the user of the marketplace application 120 may indicate that the user is in Hawaii while the default shipping delivery location indicates that the user's primary residence is in California.

The communication data may include emails to or from the user related to a travel plan. For example, the user may receive a confirmation e-mail from a travel agency, an airline company, or a hotel. The confirmation e-mails may indicate the dates of travel of the user and the destination address of the user. The shipping delivery location data mining module 302 may parse the communication data for information related to the whereabouts or travel plans of the user.

The shipping delivery location analysis module 304 determines a predicted shipping delivery address for the user based on an estimated delivery date of an order from the user and the shipping delivery data related to the user. For example, the shipping delivery location analysis module 304 accesses and mines the shipping delivery historical data of a marketplace application to determine the estimated delivery date of the order. For example, it may typically take three days to deliver an MP3 player from a particular geographic region to the geographic region of the buyer. As such, the shipping delivery location analysis module 304 may determine the estimated delivery date of the order based on historical shipping delivery data from the marketplace application 120. In another embodiment, the shipping delivery location analysis module 304 queries a shipping carrier service associated with an order of the user of the marketplace application 120 to determine the estimated delivery date of the order.

Once the shipping delivery location analysis module 304 determines the estimated delivery date of the order at a default shipping location of the user, the predicted shipping delivery address for the user is determined using the estimated delivery date of the order. For example, a user of the marketplace application 120 places an order for an item on Monday. The shipping delivery location analysis module 304 determines that the estimated delivery date is Thursday. The shipping delivery location analysis module 304 then determines the predicted shipping delivery address for the user on Thursday. For example, it may be determined from the data obtained with the shipping delivery location data mining module 302 that the user will be on vacation and out of town Thursday.

In another example, it may be determined from the data obtained with the shipping delivery location data mining module 302 that the geographic location of the user, at the time of the order, is more than 100 miles away from his default shipping delivery address (e.g., his home). However, the shipping delivery location data mining module 302 may also determine that the user will be back home Wednesday.

In one example embodiment, the shipping delivery location service module 306 suggests the predicted shipping delivery address to the marketplace application 120 to finalize the order. For example, a user places an order with the marketplace application 120 while on vacation in Hawaii on Monday. The shipping delivery location analysis module 304 determines from a travel itinerary communication to the user that the user will be in Hawaii until Sunday. Furthermore, the shipping delivery location analysis module 304 determines that it takes three days for the item to be delivered to Hawaii and two days for the item to be delivered at the default shipping delivery address (e.g., home) of the user. As such, the shipping delivery location service module 306 may suggest to the marketplace application 120 that the item be delivered at the address of the hotel where the user is staying in Hawaii. If the user were to place the order with the shipping delivery address as the address of the hotel in Hawaii, the user would receive the item on Wednesday in Hawaii.

In another example embodiment, the shipping delivery location service module 306 may suggest to the marketplace application 120 that the order be fulfilled at a later date such that the item would be received at the home of the user after Sunday when the user is to be back in town. The shipping delivery location service module 306 may continuously monitor the whereabouts of the user. For example, if a tropical storm were to delay the departure of the user back home, the shipping delivery location service module 306 may issue a request or instructions to the shipping carrier to hold delivery of the item at a shipping facility until the user arrives home.

In another example, the shipping delivery location service module 306 determines from a communication from the airline company that the user has postponed and changed the return flight from Hawaii. Similarly, the shipping delivery location service module 306 issues a request or instructions to the shipping carrier to hold delivery of the item at a shipping facility until the user arrives home. If the shipping delivery location service module 306 determines that the postponement of the return flight allows enough time for the already shipping item to be redirected to the vacation address of the user in Hawaii, the shipping delivery location service module 306 may confirm with the user if the user wishes to have the already shipping item redirected to the vacation address in Hawaii. For example, if the user postpones his return flight by one week, and the shipping delivery location service module 306 determines that the item could be redirected to be delivery in Hawaii before the user leaves Hawaii, the shipping delivery location service module 306 may ask the user whether the item should be redirected to Hawaii or be placed on hold for pick up at a shipping facility near his default residence address.

In yet another example embodiment, the shipping delivery location service module 306 requests a supplemental shipping service for an order that has already been fulfilled for a shipping delivery address different than the predicted shipping delivery address. For example, the predicted shipping delivery address is the address of the hotel in Hawaii while the shipping delivery address used in an order already placed is the home of the user.

The supplemental shipping service may include a request to place a hold on the order that has already been fulfilled for the shipping delivery address different than the predicted shipping delivery address, with a corresponding shipping carrier provider. For example, the shipping delivery location service module 306 may alert the shipping carrier provider used to ship the item to delay delivering the item by holding the item at a shipping facility close to the shipping delivery address used in the order. The request to place the hold may include more specific information such as holding the item for delivery until a specific date (e.g., Monday when the user is back home) or holding the item until the user picks it up from the shipping facility.

The supplemental shipping service may also include a request to redirect shipping delivery to an alternative shipping delivery address determined using the shipping delivery data of the user. For example, the shipping delivery location service module 306 may request that the shipping carrier provider used to ship the item redirect shipping of the item to the hotel in Hawaii where the user is staying. It is noted that the extra time to redirect the shipment of the item is taken into account such that delivery of the item in Hawaii is before the user leaves the hotel in Hawaii.

### Example Scenario

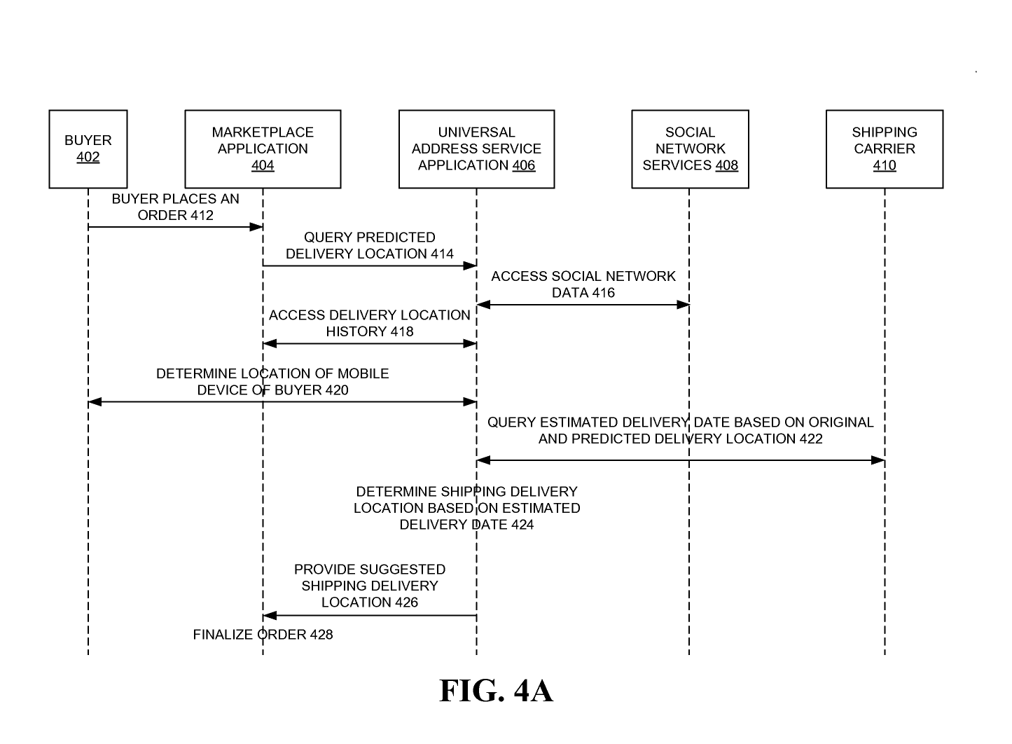

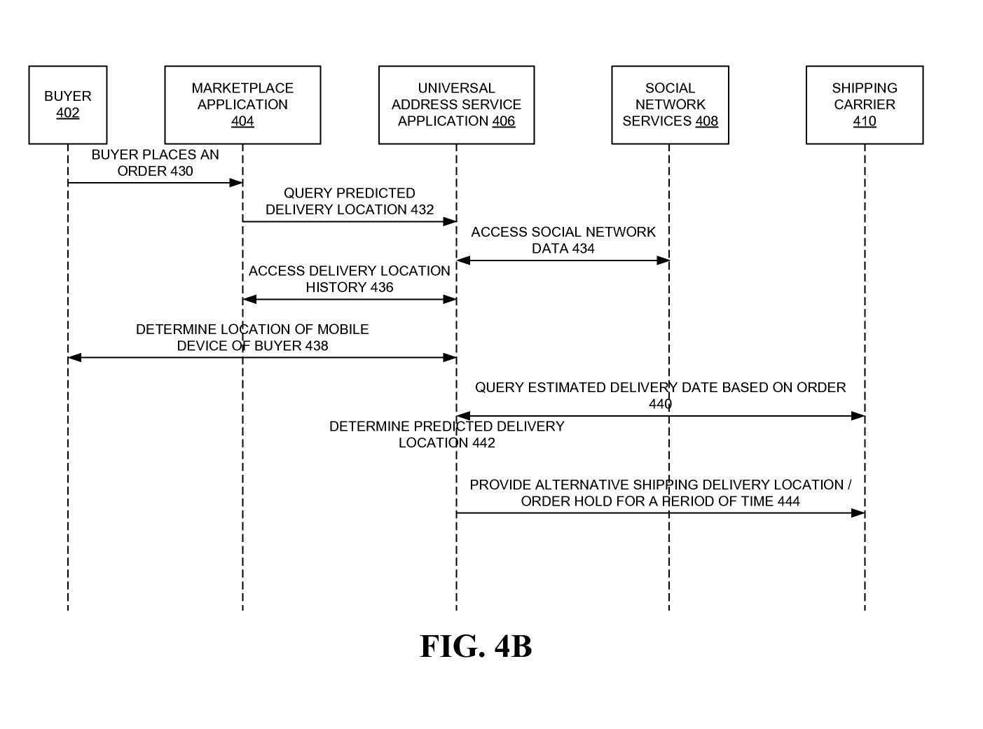

FIG. 4A is a ladder diagram illustrating an example of an operation of the universal address service application 122 that operates with the online marketplace application 120.

At operation 412, the buyer 402 places an order with the marketplace application 404. It is noted that the order is not finalized and not yet fulfilled in this example. In other words, the buyer 402 has placed an item in a shopping cart and is performing a check out process where the order information is to be confirmed by the buyer 402.

At operation 414, the marketplace application 404 queries the universal address service application 406 to determine a predicted delivery location.

At operation 416, the universal address service application 406 accesses social network data from social network services 408 associated with the buyer 402.

At operation 418, the universal address service application 406 accesses the delivery location history data from the marketplace application 404 to determine the address of past items delivered and their corresponding dates.

At operation 420, the universal address service application 406 determines a geographic location of the mobile device of the buyer 402. In other words, it may be determined whether the user is out of town (e.g., more than x miles from the default shipping delivery address of the user) at the time of the order or anytime thereafter.

At operation 422, the universal address service application 406 queries a shipping carrier 410 associated with the order to determine an estimated delivery date based on the buyer's default delivery address and a predicted delivery location for the order. For example, the shipping carrier 410 determines that the item would arrive Friday at the default delivery address (e.g., home address) of the user and Thursday at the predicted delivery location of the user (e.g., hotel address).

At operation 424, the universal address service application 406 determines a predicted shipping delivery location based on the estimated delivery date.

At operation 426, the universal address service application 406 provides a suggested shipping delivery location to the marketplace application 404 for the order from the buyer 402. For example, a shipping delivery address may be suggested to the buyer 402 prior to finalizing the order at operation 428.

FIG. 4B is a ladder diagram illustrating an example of an operation of the universal address service application 122 that operates with the online marketplace application 120.

At operation 430, the buyer 402 places an order with the marketplace application 404. It is noted that the order is finalized for shipping fulfilment to the address specified in the order. In other words, the buyer 402 has completed the checkout process and confirmed the order.

At operation 432, the marketplace application 404 queries the universal address service application 406 to determine a predicted delivery location.

At operation 434, the universal address service application 406 accesses social network data from social network services 408 associated with the buyer 402.

At operation 436, the universal address service application 406 accesses the delivery location history data from the marketplace application 404 to determine where items have been delivered in the past and on which dates.

At operation 438, the universal address service application 406 determines a geographic location of the mobile device of the buyer 402. In other words, it may be determined whether the user is out of town at the time of the order or anytime thereafter.

At operation 440, the universal address service application 406 queries a shipping carrier 410 associated with the order to determine an estimated delivery date based on a default delivery location and a predicted delivery location for the order.

At operation 442, the universal address service application 406 determines a predicted shipping delivery location based on the estimated delivery date.

At operation 444, the universal address service application 406 generates a request to provide an alternative shipping delivery location for the user or to hold the order for a period of time.

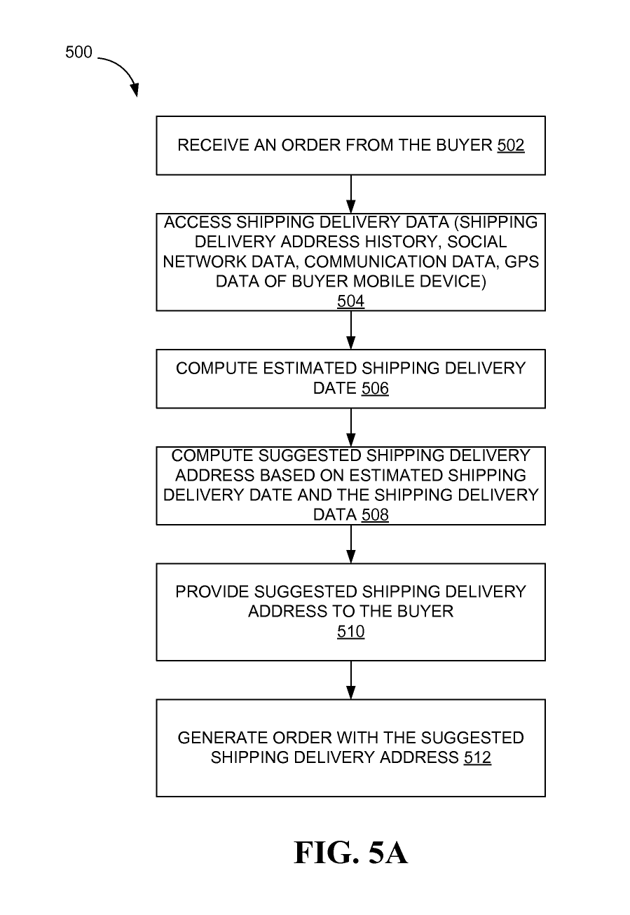

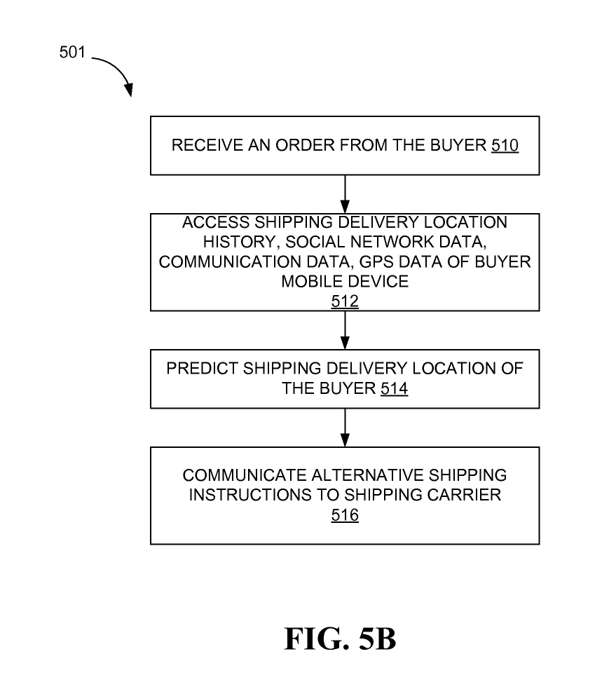

FIG. 5A shows a flow diagram illustrating one example embodiment of a method 500 for a universal address service. The method 500 may be performed, in whole or in part, by the universal address service application 122, using modules discussed above with respect to FIG. 3.

At operation 502, the universal address service application 122 receives an order from the buyer via the marketplace application 120. At operation 504, shipping delivery data is accessed. For example, the shipping delivery data may include shipping delivery address history, social network data, communication data, and GPS location data of the mobile device of the buyer.

At operation 506, the universal address service application 122 computes an estimated shipping delivery date. At operation 508, a suggested shipping delivery address is determined based on the estimated shipping delivery date and the shipping delivery data. At operation 510, the universal address service application 122 provides the suggested shipping delivery address to the buyer before the buyer finalizes the order. At operation 512, the marketplace application 120 generates the order with the suggested shipping delivery address.

FIG. 5B shows a flow diagram illustrating one example embodiment of a method 501 for a universal address service. The method 501 may be performed, in whole or in part, by the universal address service application 122, using modules discussed above with respect to FIG. 3.

At operation 510, the universal address service application 122 receives an order from the buyer via the marketplace application 120. At operation 512, shipping delivery data is accessed. For example, the shipping delivery data may include shipping delivery address history, social network data, communication data, GPS location data of the mobile device of the buyer.

At operation 514, the universal address service application 122 predicts a shipping delivery location of the buyer. At operation 516, the universal address service application 122 communicates alternative shipping instructions to a shipping carrier associated with the order. The alternative shipping instructions may include, for example, holding delivery of the item or redirecting shipment of the item to another address (e.g., the predicted shipping delivery location of the buyer).

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed, in various example embodiments.

### Example Computer System

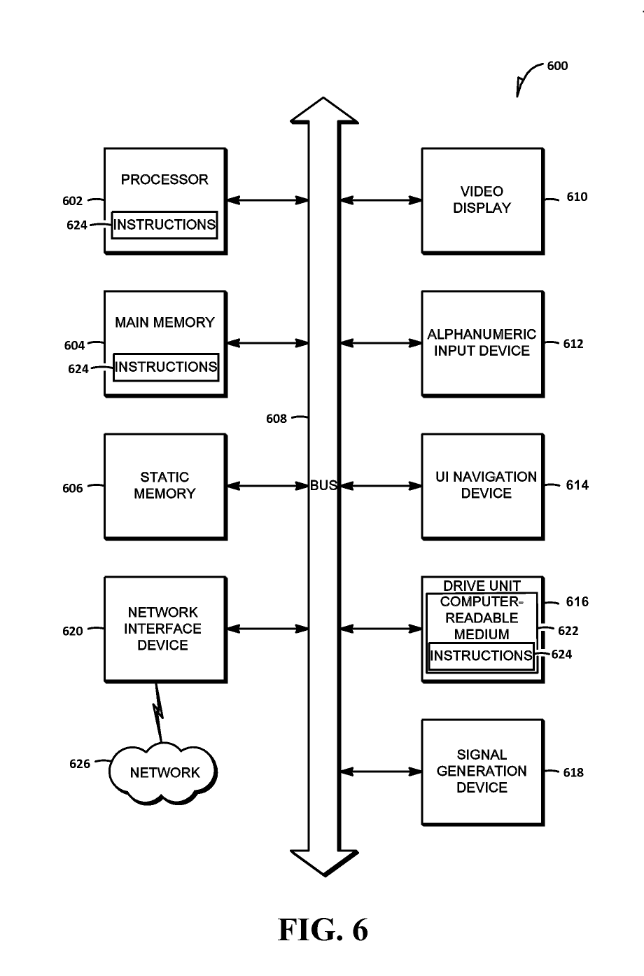

FIG. 6 shows a diagrammatic representation of a machine in the example form of a computer system 600 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a UI navigation device 614 (e.g., a mouse), a disk drive unit 616, a signal generation device 618 (e.g., a speaker), and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., HTTP).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions 624. The term “machine-readable medium” shall also be taken to include any medium that is capable of storing, encoding, or carrying a set of instructions 624 for execution by the machine and that cause the machine to perform any one or more of the methodologies of the present disclosure, or that is capable of storing, encoding or carrying data structures utilized by or associated with such a set of instructions 624. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A universal address service system comprising:
a shipping delivery location data mining module executable by a processor configured to access shipping delivery data related to a user, the shipping delivery data comprising a history of shipping delivery addresses with corresponding shipping delivery dates;
a shipping delivery location analysis module configured to determine a predicted shipping delivery address for the user based on an estimated delivery date of an order from the user and the shipping delivery data related to the user; and
a shipping delivery location service module configured to generate the order with the predicted shipping delivery address.

2. The universal address service system of claim 1, wherein the shipping delivery location service module is configured to request a supplemental shipping service for an order that has already been fulfilled for a shipping delivery address different than the predicted shipping delivery address.

3. The universal address service system of claim 2, wherein the supplemental shipping service comprises a request to place a hold on the order that has already been fulfilled for the shipping delivery address different than the predicted shipping delivery address, with a corresponding shipping carrier provider.

4. The universal address service system of claim 2, wherein the supplemental shipping service comprises a request to redirect shipping delivery to an alternative shipping delivery address determined using the shipping delivery data of the user.

5. The universal address service system of claim 1, wherein the shipping delivery location analysis module is configured to access shipping delivery historical data of a marketplace application to determine the estimated delivery date of the order.

6. The universal address service system of claim 1, wherein the shipping delivery location analysis module is configured to query a shipping carrier service to determine the estimated delivery date of the order.

7. The universal address service system of claim 1, wherein the shipping delivery data further comprises social network data related to the user, geographic location data of a mobile device of the user, and communication data of the user.

8. The universal address service system of claim 7, wherein the shipping delivery location data mining module parses the social network data and the communication data for communication related to a travel plan of the user,

9. The universal address service system of claim 7, wherein the shipping delivery location data mining module parses the geographic location data of the mobile device of the user to determine whether a threshold distance between a location of the mobile device and the default shipping delivery location exceeds a threshold distance for a number of days.

10. The universal address service system of claim 1, wherein the shipping delivery location service module is configured to suggest the predicted shipping delivery address for the user, and to receive confirmation from the user to ship to the predicted shipping delivery address before generating the order.

11. A method comprising:
accessing shipping delivery data related to a user, the shipping delivery data comprising a history of shipping delivery addresses with corresponding shipping delivery dates;
determining a predicted shipping delivery address for the user based on an estimated delivery date of an order from the user and the shipping delivery data related to the user; and
generating the order with the predicted shipping delivery address.

12. The method of claim 11, further comprising:
requesting a supplemental shipping service for an order that has already been fulfilled for a shipping delivery address different than the predicted shipping delivery address.

13. The method of claim 12, further comprising:
requesting a hold on the order that has already been fulfilled for the shipping delivery address different than the predicted shipping delivery address, with a corresponding shipping carrier provider.

14. The method of claim 12, further comprising:
requesting a redirected shipping delivery to an alternative shipping delivery address determined using the shipping delivery data of the user.

15. The method of claim 11, further comprising:
accessing shipping delivery historical data of a marketplace application to determine the estimated delivery date of the order.

16. The method of claim 11, further comprising:
querying a shipping carrier service to determine the estimated delivery date of the order.

17. The method of claim 11, wherein the shipping delivery data further comprises social network data related to the user, geographic location data of a mobile device of the user, and communication data of the user.

18. The method of claim 17, further comprising:
parsing the social network data and the communication data for communication related to a travel plan of the user; and
parsing the geographic location data of the mobile device of the user to determine whether a distance between a location of the mobile device and the default shipping delivery location exceeds a threshold distance for a number of days.

19. The method of claim 11, further comprising:
providing a suggestion of the predicted shipping delivery address to the user; and
receiving confirmation from the user to ship to the predicted shipping delivery address before generating the order.

20. A non-transitory computer-readable storage medium storing a set of instructions that, when executed by a processor, cause the processor to perform operations, comprising:
accessing shipping delivery data related to a user, the shipping delivery data comprising a history of shipping delivery addresses with corresponding shipping delivery dates;
determining a predicted shipping delivery address for the user based on an estimated delivery date of an order from the user and the shipping delivery data related to the user; and
generating the order with the predicted shipping delivery address.
